(19) United States
(12) Patent Application Publication
(10) Pub. No.: US 2010/0046224 A1
(43) Pub. Date: Feb. 25, 2010

(54) ILLUMINATION DEVICE

(75) Inventor: Geng-Sheng Lin, Tainan County (TW)

Correspondence Address: BANNER & WITCOFF, LTD., 1100 13th STREET, N.W., SUITE 1200, WASHINGTON, DC, 20005-4051, US

(73) Assignee: MAXZONE VEHICHLE LIGHTING CORP., Fontana, CA (US)

(21) Appl. No.: 12/612,737

(22) Filed: Nov. 5, 2009

(30) Foreign Application Priority Data
Aug. 22, 2008 (TW) 097215182

(51) Int. Cl. F21S 4/00

(52) U.S. Cl. 362/249.02

(57) ABSTRACT

An illumination device includes a circuit board unit having positioning hole units corresponding respectively to LEDs mounted thereon. Each positioning hole unit includes a first positioning hole, and a second positioning hole having a diameter larger than that of the first positioning hole. A lamp seat has positioning post units corresponding respectively to the positioning hole units in the circuit board unit. Each positioning post unit includes a first positioning post, and a second positioning post having a width larger than that of the first positioning post. When the circuit board unit is mounted on the lamp seat, the first and second positioning posts of each positioning post unit respectively extend through and engage the first and second positioning holes of a corresponding positioning hole unit in the circuit board unit, thereby positioning the circuit board unit to the lamp seat.

### BACKGROUND OF THE INVENTION

1. Field of the Invention

The invention relates to an illumination device, more particularly to an illumination device mounted with light emitting diodes (LEDs).

2. Description of the Related Art

FIG. 1 illustrates a conventional LED illumination device 1 that includes a lamp seat 12 and a circuit board 11. The lamp seat 12 has a mounting surface 120 formed with two thread holes 123, opposite conductive contacts 124 disposed on the mounting surface 120 for receiving an applied voltage, and opposite positioning posts 121 extending from the mounting surface 120. The circuit board 11 is mounted with an LED 13 thereon, has a periphery formed with a plurality of angularly equidistant notches 111, and is disposed on the mounting surface 120 of the lamp seat 12 such that anode and cathode of the LED 13 contact electrically and respectively the conductive contacts 124. The positioning posts 121 of the lamp seat 12 engage respectively two corresponding ones of the notches 111 in the circuit board 11, thereby positioning the circuit board 11 to the lamp seat 12.

However, when assembling the circuit board 11 to the lamp seat 12, an inversed voltage may be applied to the LED 13 due to misplacement of the circuit board 11 on the lamp seat 12, thereby resulting in damage to the LED 13.

### SUMMARY OF THE INVENTION

Therefore, an object of the present invention is to provide an illumination device that can overcome the aforesaid drawbacks of the prior art.

According to one aspect of the present invention, an illumination device comprises:

a circuit board unit for mounting a plurality of light emitting diodes (LEDs) thereon, the circuit board unit being formed with a plurality of positioning hole units corresponding respectively to the LEDs, each of the positioning hole units including a first positioning hole, and a second positioning hole having a diameter larger than that of the first positioning hole; and

a lamp seat for mounting the circuit board unit thereon, the lamp seat having a plurality of positioning post units corresponding respectively to the positioning hole units in the circuit board unit, each of the positioning post units including a first positioning post, and a second positioning post having a width larger than that of the first positioning post, the first and second positioning posts of each of the positioning post units respectively extending through and engaging the first and second positioning holes of a corresponding one of the positioning hole units in the circuit board unit when the circuit board unit is mounted on the lamp seat, thereby positioning the circuit board unit to the lamp seat.

According to another aspect of the present invention, an illumination device comprises:

a circuit board for mounting a light emitting diode (LED) thereon, the circuit board being formed with a first positioning hole, and a second positioning hole having a diameter larger than that of the first positioning hole; and

a lamp seat for mounting the circuit board thereon, the lamp seat having first and second positioning posts corresponding respectively to the first and second positioning holes in the circuit board, the second positioning post having a width larger than that of the first positioning post, the first and second positioning posts respectively extending through and engaging the first and second positioning holes in the circuit board when the circuit board is mounted on the lamp seat, thereby positioning the circuit board to the lamp seat.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view showing a conventional LED illumination device;

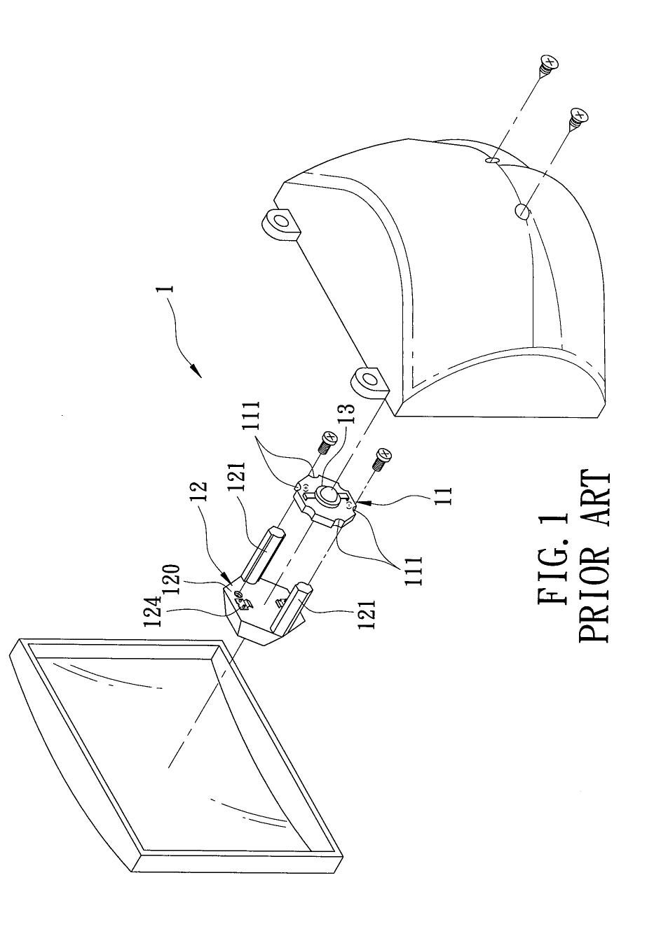

FIG. 2 is an exploded perspective view showing the first preferred embodiment of an illumination device according to the present invention;

FIG. 3 is an assembled perspective view showing a circuit board unit and a lamp seat of the first preferred embodiment;

FIG. 4 is an exploded perspective view showing the second preferred embodiment of an illumination device according to the present invention; and

FIG. 5 is an assembled perspective view showing a circuit board unit and a lamp seat of the second preferred embodiment.

### DETAILED DESCRIPTION OF THE PREFERRED EMBODIMENTS

Before the present invention is described in greater detail, it should be noted that like elements are denoted by the same reference numerals throughout the disclosure.

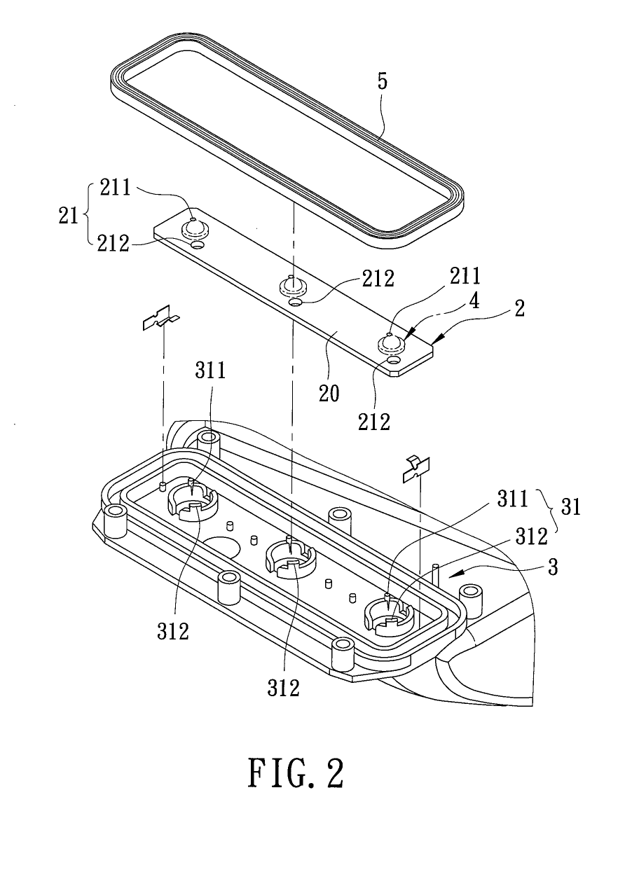

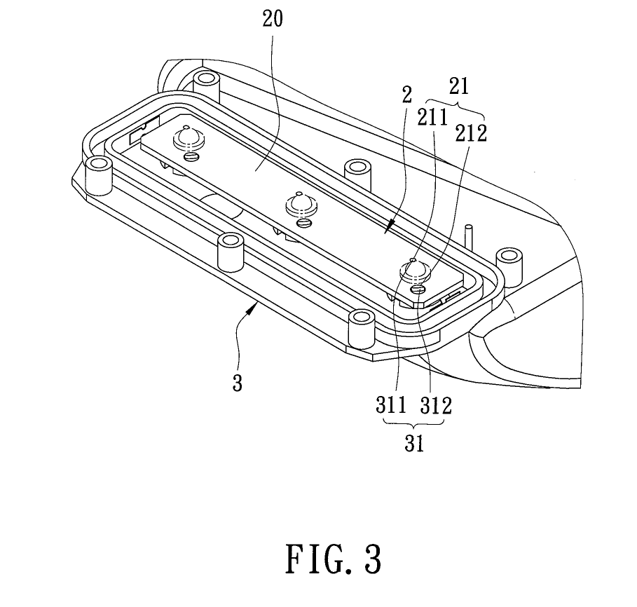

Referring to FIGS. 2 and 3, the first preferred embodiment of an illumination device according to the present invention is shown to include an LED unit, a circuit board unit 2, a lamp seat 3, and a lamp cover 5.

In this embodiment, the LED unit includes a plurality of LEDs 4.

The circuit board unit 2 includes a unitary circuit board 20 in this embodiment, and is mounted with the LEDs 4 thereon. The circuit board 20 is formed with a plurality of positioning hole units 21 corresponding respectively to the LEDs 4. Each positioning hole unit 21 includes a first positioning hole 211, and a second positioning hole 212 having a diameter larger than that of the first positioning hole 211.

The lamp seat 3 is mounted with the circuit board unit 2 thereon, and has a plurality of positioning post units 31 corresponding respectively to the positioning hole units 21 in the circuit board 20. Each positioning post unit 31 includes a first positioning post 311, and a second positioning post 312 having a width larger than that of the first positioning post 311. The first and second positioning posts 311, 312 of each positioning post unit 31 respectively extend through and engage the first and second positioning holes 211, 212 of a corresponding positioning hole unit 21 in the circuit board 20 when the circuit board 2 is mounted on the lamp seat 3, as shown in FIG. 3, thereby positioning the circuit board unit 2 to the lamp seat 3.

The lamp cover 5 is connected to the lamp seat 3 to cover the circuit board unit 2.

It is noted that, in other embodiments, when the LED unit includes a single LED 4 that is mounted on the circuit board 20, only one positioning hole unit 21 is required for the circuit board unit 2, and only one positioning post unit 31 is required for the lamp seat 3.

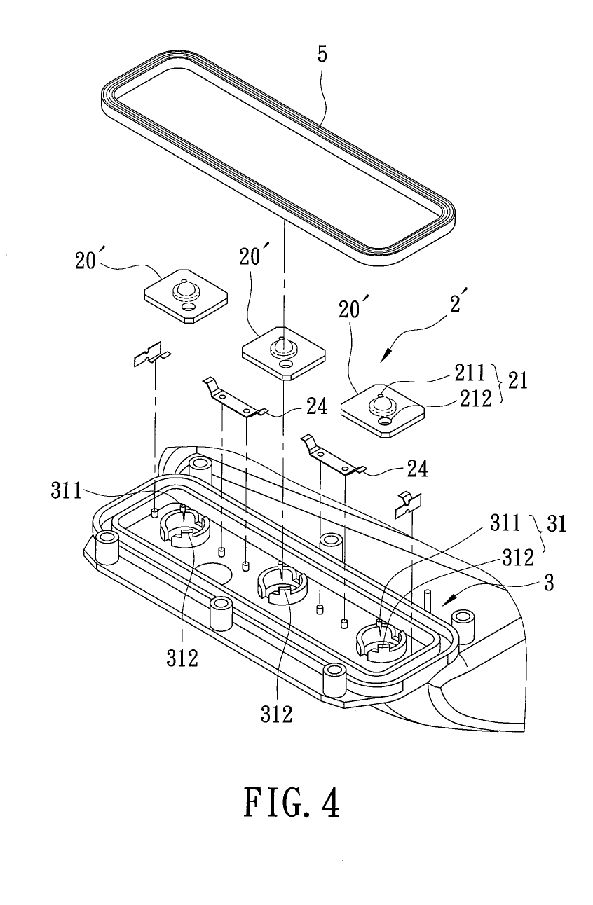

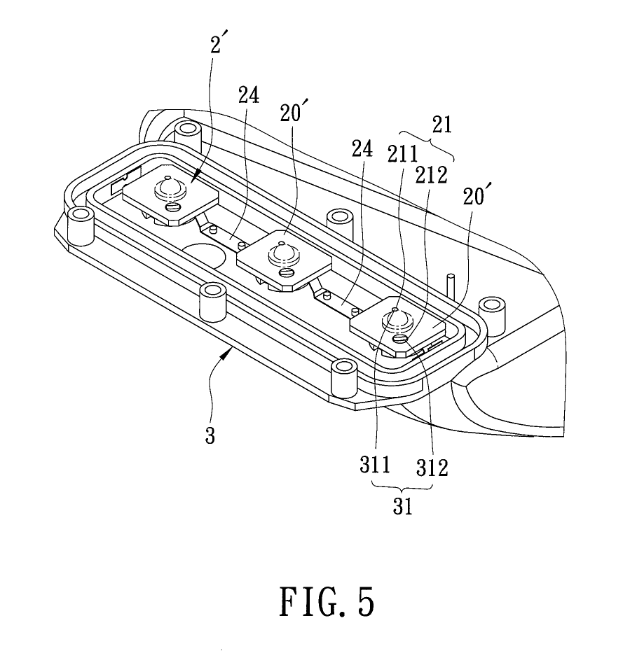

FIGS. 4 and 5 illustrate the second preferred embodiment of an illumination device according to this invention, which is a modification of the first preferred embodiment. In this embodiment, the circuit board unit 2′ includes a plurality of circuit boards 20′, and a plurality of conductive elements 24.

The circuit boards 20′ are spaced apart from each other. Each circuit board 20′ is formed with a corresponding positioning hole unit 21.

Each conducting element 24 interconnects electrically a respective adjacent pair of the circuit boards 20′. In this embodiment, each conducting element 24 is in the form of a resilient conductive plate. In other embodiments, each conducting element 24 can be an electrical wire.

In sum, since the first and second positioning holes 211, 212 of each positioning hole unit 21 have different diameters and since the first and second positioning posts 311, 312 of each positioning post unit 31 have different widths, misplacement of the circuit board unit 2, 2′ on the lamp seat 3 can be avoided. Therefore, the illumination device of the present invention can be accurately and quickly assembled.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An illumination device comprising:
a circuit board unit for mounting a plurality of light emitting diodes (LEDs) thereon, said circuit board unit being formed with a plurality of positioning hole units corresponding respectively to the LEDs, each of said positioning hole units including a first positioning hole, and a second positioning hole having a diameter larger than that of said first positioning hole; and
a lamp seat for mounting said circuit board unit thereon, said lamp seat having a plurality of positioning post units corresponding respectively to said positioning hole units in said circuit board unit, each of said positioning post units including a first positioning post, and a second positioning post having a width larger than that of said first positioning post, said first and second positioning posts of each of said positioning post units respectively extending through and engaging said first and second positioning holes of a corresponding one of said positioning hole units in said circuit board unit when said circuit board unit is mounted on said lamp seat, thereby positioning said circuit board unit to said lamp seat.

2. The illumination device as claimed in Claim 1, wherein said circuit board unit includes a unitary circuit board formed with said positioning hole units.

3. The illumination device as claimed in claim 1, wherein said circuit board unit includes:
a plurality of circuit boards spaced apart from each other, each of said circuit boards being formed with a corresponding one of said positioning hole units; and
a plurality of conducting elements each interconnecting electrically a respective adjacent pair of said circuit boards.

4. The illumination device as claimed in claim 3, wherein each of said conducting elements is in the form of a resilient conductive plate.

5. The illumination device as claimed in claim 3, wherein each of said conducting elements is an electrical wire.

6. An illumination device comprising:
a circuit board for mounting a light emitting diode (LED) thereon, said circuit board being formed with a first positioning hole, and a second positioning hole having a diameter larger than that of said first positioning hole; and
a lamp seat for mounting said circuit board thereon, said lamp seat having first and second positioning posts corresponding respectively to said first and second positioning holes in said circuit board, said second positioning post having a width larger than that of said first positioning post, said first and second positioning posts respectively extending through and engaging said first and second positioning holes in said circuit board when said circuit board is mounted on said lamp seat, thereby positioning said circuit board to said lamp seat.
